(19) United States
(12) Patent Application Publication
(10) Pub. No.: US 2016/0273746 A9
(43) Pub. Date: Sep. 22, 2016

(54) Lighting Assembly for a Ladder

(71) Applicant: Adaptive Rescue Concepts, LLC, Plainfield, IL (US)

(72) Inventors: Bruce Michael Bina, Plainfield, IL (US); Todd David Miller, Elkhart, IN (US); Kenneth Chester Wojcik, Naperville, IL (US); Richard Kenneth Banske, Calumet City, IL (US); Kenneth John Lee, Highland, IN (US); Robert J. Groszewski, Munster, IN (US); David Steven Schuman, Naperville, IL (US)

(21) Appl. No.: 14/244,472

(22) Filed: Apr. 3, 2014

Related U.S. Application Data
(60) Provisional application No. 61/807,912, filed on Apr. 3, 2013.

(51) Int. Cl. F21V 21/088; E06C 7/50; F21V 23/00; E06C 7/00

(52) U.S. Cl. CPC F21V 21/088; E06C 7/00; E06C 7/50; F21V 23/003; F21Y 2101/02

(57) ABSTRACT

A lighting assembly for a ladder. The assembly has a lighting unit and a mount. The lighting unit has a housing, a controller, a LED group, and a user input device. The controller is signal connected to the user input device and the LED group. The LED group has a plurality of LEDs. The mount is connected to the lighting unit. One mount has a ladder rung receiver and a locking arm. The locking arm is movable between an open position to allow a ladder rung to be received in the run receiver and at least one closed position to secure the ladder run in the rung receiver. Another mount has a toggle anchor for engaging a ladder side rail channel.

This application claims the benefit of U.S. Patent Application No. 61/807,912, filed on Apr. 3, 2013, which is incorporated herein by reference in its entirety.

### FIELD OF THE INVENTION

This invention relates in general to lighting devices for use with ladders.

### BACKGROUND OF THE INVENTION

Some conventional ladder lighting techniques that many emergency workers, such as firefighters, presently use involve applying reflective tape material to the ladder. In most cases, this reflective tape material requires a light source that shines directly on the tape's reflective surface in order for it to be effective. Once the light source is removed, the reflective material is no longer visible and the rescue team is unable to locate the rescue ladder. Other methods for lighting the rescue ladder involve tying a flashlight to the ladder rung or rail. The light from the flash light only points in one direction and can hinder the movement and location of the ladder.

The present inventors recognized the need for a more stable light source for identifying the location of the rescue ladder or portion of the ladder, particularly in smoke filled conditions. The present inventors recognized the need to a light assembly with improved mount for use with a ladder. The present inventors recognized the need for light that is moveable relative to the ladder so the light can be easily directed where desired. The present inventors recognized the need for a lighting assembly to provide temperature and location information.

### SUMMARY OF THE INVENTION

A lighting assembly for a ladder is disclosed. The assembly has a lighting unit and a mount. The lighting unit has a housing, a controller, a light group, and a user input device. The controller is signal connected to the user input device and the light group. The light group has a plurality of LEDs. The mount is connected to the lighting unit. The mount has a ladder rung receiver and a locking arm. The locking arm is movable between an open position to allow a ladder rung to be received in the rung receiver and at least one closed position to secure the ladder run in the rung receiver.

In some embodiments, the mount has a mounting member and a shaft. The lighting unit is connected to the mounting member. The mounting member is rotatably connected to the shaft.

In some embodiments, the rung receiver is attached to the shaft opposite of the mounting member. In some embodiments, the rung receiver is rotatably mounted to the shaft.

In some embodiments, the mount has a locking mechanism to releasably lock the mounting member against rotation relative to the shaft.

In some embodiments, the rung receiver has a plurality of recesses. The locking arm is pivotally attached to the run receiver. The locking arm is engagable with at least one of the plurality of recesses to releaseably lock the locking arm in the at least one closed position.

In some embodiments, the locking arm is moveable from an extended position, where the locking arm is released from the plurality of recesses and a retracted position where the locking arm is engaged with at least one of the plurality of recesses.

In some embodiments, the locking arm has a plurality of closed positions. Each closed position corresponds to one of the plurality of recesses. The locking arm is movable between the plurality of closed positions to vary the area between the locking arm and the rung receiver.

In some embodiments, the lighting group has a first LED subgroup and a second LED subgroup. The first LED subgroup has LEDs of a first color. The second LED subgroup has LEDs of a second color. The user input device has a lighting color selector. The controller has a function to illuminate the first or second LED subgroup depending on the color indicated by the user via the color selector.

In some embodiments, the user input device is a mode color selector. The controller has a function to illuminate the lighting group constantly or to flash the LED group on and off depending on the mode indicated by the user via the mode selector.

In some embodiments, the housing provides a waterproof enclosure.

In some embodiments, the mount is a rail mount having a toggle anchor for engaging a ladder side rail channel.

In some embodiments, the mount has a lighting unit mounting member and threaded shaft connected to the mounting member. The toggle anchor is threadedly connected with the threaded shaft.

In some embodiments, the toggle anchor has two wings, a spring, and a threaded member. The wings are pivotally mounted to the threaded member. The wings are pivotal between a closed position and an open position. The spring is attached to the threaded member and contacts each of the wings to bias the wings toward the open position. The threaded shaft connects to the threaded member of the toggle anchor. The threaded shaft is rotatable to tighten or loosen the toggle anchor relative to the mounting member to secure the toggle anchor within a ladder side rail channel.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a perspective view of a ladder light assembly of the invention deployed on a ladder.

FIG. 2 is a front view of the ladder light assembly of FIG. 1.

FIG. 3 is a side view of the ladder light assembly of FIG. 2.

FIG. 4 is a schematic diagram of certain components of a lighting unit of the ladder light assembly of FIG. 2.

FIG. 5 is a flow diagram of one or more processes of a controller of the lighting unit of FIG. 2.

FIG. 6 is a front view of an alternative embodiment ladder light assembly having a rail mount connected to a rail of a ladder.

FIG. 7 is a perspective view of the ladder light assembly of FIG. 6.

FIG. 8 is a side view of a toggle anchor of the ladder light assembly of FIG. 6 in a cross-section of a rail of a ladder.

FIG. 9 is a bottom view of a toggle anchor of the ladder light assembly of FIG. 6.

FIG. 10 is a perspective view of the ladder light assembly of FIG. 6 mounted to a ladder rail.

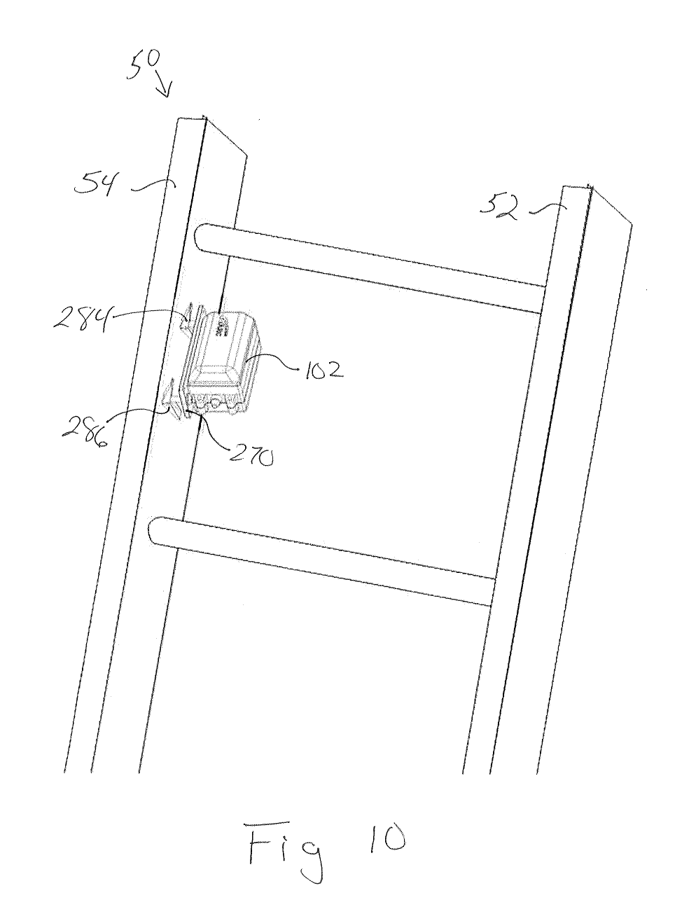

FIG. 11 is a perspective view of the ladder light assembly of FIG. 6 deployed in an application.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

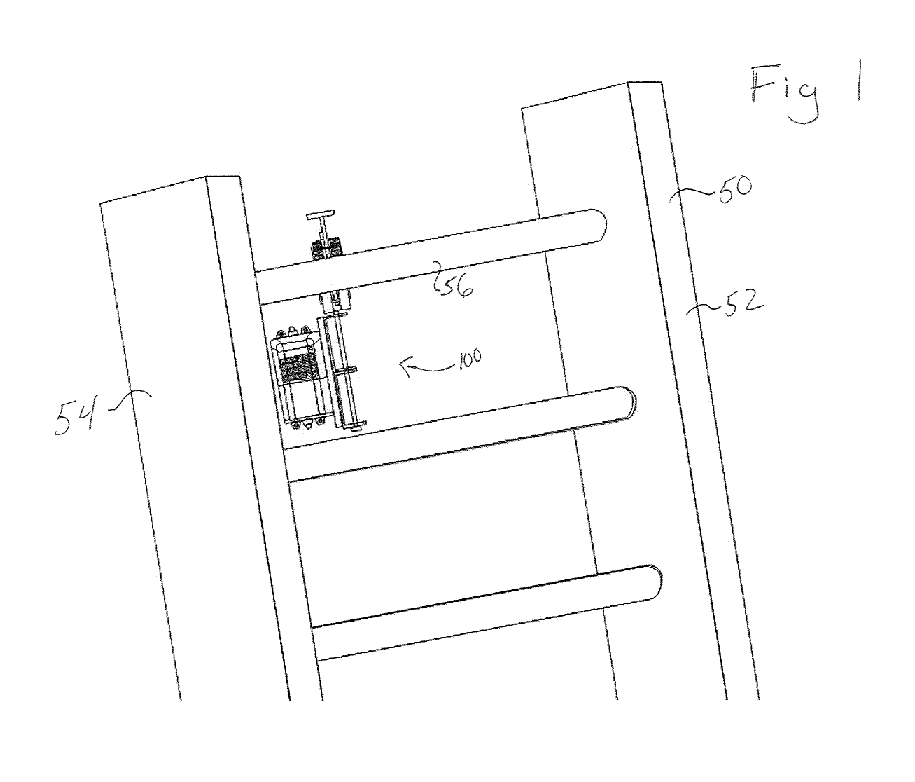

FIGS. 1-3 show a ladder light assembly 100 of the invention. The ladder light assembly comprises a lighting unit 102, a lighting unit mount 104, a main shaft 106, and a rung mount 108.

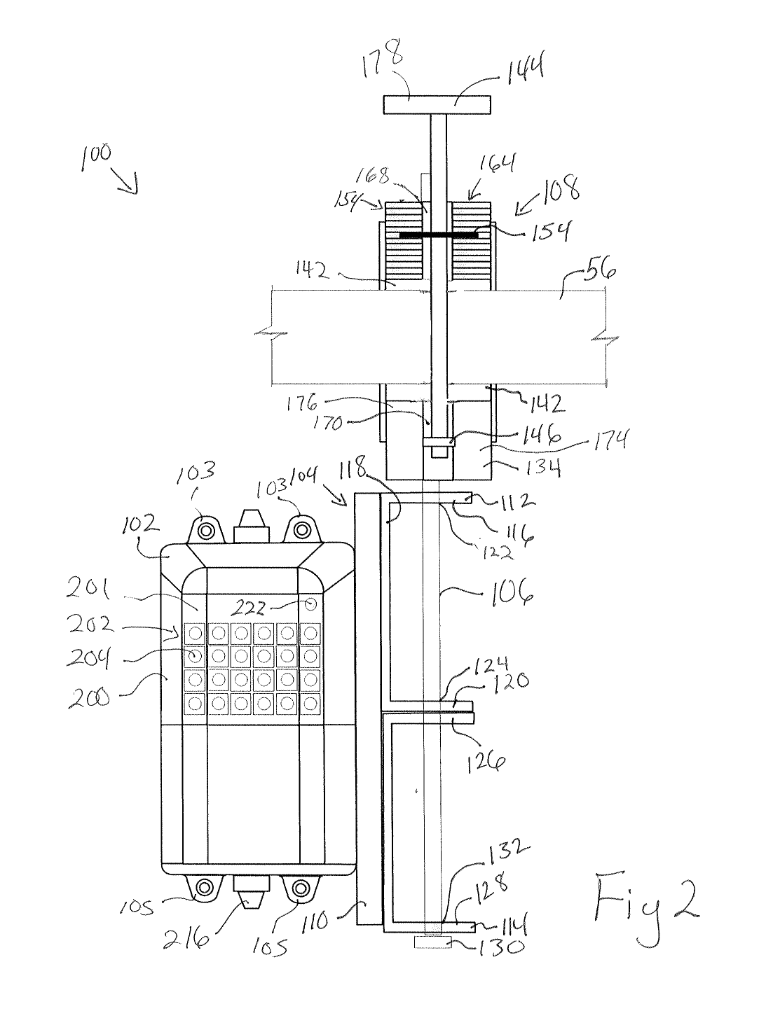

The lighting unit mount 104 comprises a mounting plate 110, an upper main shaft mount 112, and a lower main shaft mount 114. Each of the upper and lower main shaft mounts are identical so only the upper main shaft mount will be described. The mount 112 comprises an upper portion 116, a middle portion 118, and a lower portion 120. The portions 116, 120 are connected to portion 118 at right angles. The portions 116, 118, 120 may be formed as one unit. The mount 112 has an open side opposite the middle portion 118. Each of the upper and lower portions 116, 120 comprise a through-going upper and lower aperture 122, 124 respectively. The apertures 122,124 are sized to receive the main shaft 106. As shown in the FIG. 2, the main shaft extends through an open area between the upper and lower portions 116, 120 and through the appatures 122, 124.

The upper and lower main shaft mounts 112, 114 are joined to the lighting unit mount 104 by welding or fasteners (not shown) along the middle portions 118. The upper and lower main shaft mounts 112, 114 may also be joined to each other by welding or fasteners (not shown) along the adjacent lower portion 120 and upper portion 126. A stopping element or nut 130 is provided attached, such as by a threaded attachment, with a threaded end portion 131 of the shaft 106. The stopping element is larger than the aperture 132 in the lower portion 128 of at least the lower main shaft mount 114. Therefore the stopping element prevents the upper and lower lighting main shaft mounts 112, 114 from falling off the bottom of the main shaft.

The upper and lower main shaft mounts 112, 114 are rotatable 360 degrees about the main shaft. In some embodiments there the stopping nut 130 releasably locks the upper and lower main shaft mounts 112, 114 against rotation about the main shaft so that the light is directed to the desired location. The stopping nut locks against rotation by compressive friction force on the bottom of mount 114, which presses through mount 112 against spacer 192 that is fixed to the main shaft 106. If the spacer is not fixed to the shaft, the force is then transferred through the spacer into a rail receiver mount 180 and against a stop washer 194. This compressive force will prevent mounts 112, 114 and mount 180 from rotation. Therefore, the rotational position of mounts 112, 114, and 180 may be set before the stopping nut is fully tightened to lock the mounts against rotation.

The rung mount 108 enables the lighting assembly 100 to be attached to the rungs of a ladder. One example ladder is a conventional ladder having two spaced apart side rails 52, 54 connected by a plurality of rungs as shown in FIG. 1. The lighting assembly 100 may be attached to any ladder.

The rung mount 108 comprises a rail receiver 134. The rail receiver has a c-shaped opening 136. The c-shaped opening is formed by a lower wall 138, a back curved wall 142 and an upper wall 140. The rung 56 of a ladder 50 can be received in the c-shaped opening against the back curved wall 142. A locking arm 144 is pivotally attached at a pivot shaft 146. The locking arm has a pivot shaft connector 148 at one end. The pivot shaft connector is either fixed to the pivot shaft or pivots about the pivot shaft. The pivot shaft connector is connected to a rail engaging segment 150. The rail engaging segment is connected to a handle 152 opposite the pivot shaft connection 148. The locking arm 144 has a crossbar 154.

The rail receiver 134 comprises two toothed sections 156, 164 on upper portions of the rail receiver. The toothed sections 156, 164 are spaced apart from each other. Each toothed section comprises a plurality of recess 160 bounded on opposite sides by raised portions 158, 162. In some embodiments the raised portions 158, 162 are teeth.

As shown in FIG. 2, the locking arm is mounted on the pivot shaft 146 and movable in and out of an upper slot 168 between the toothed sections 156, 164. The locking arm also travels in a lower slot 170 between opposite lower portions 174, 176 of the rail receiver 134. The upper slot 168 and the lower slot 170 allow the locking arm 144 to enter the c-shaped opening 136 and engage the rung 56.

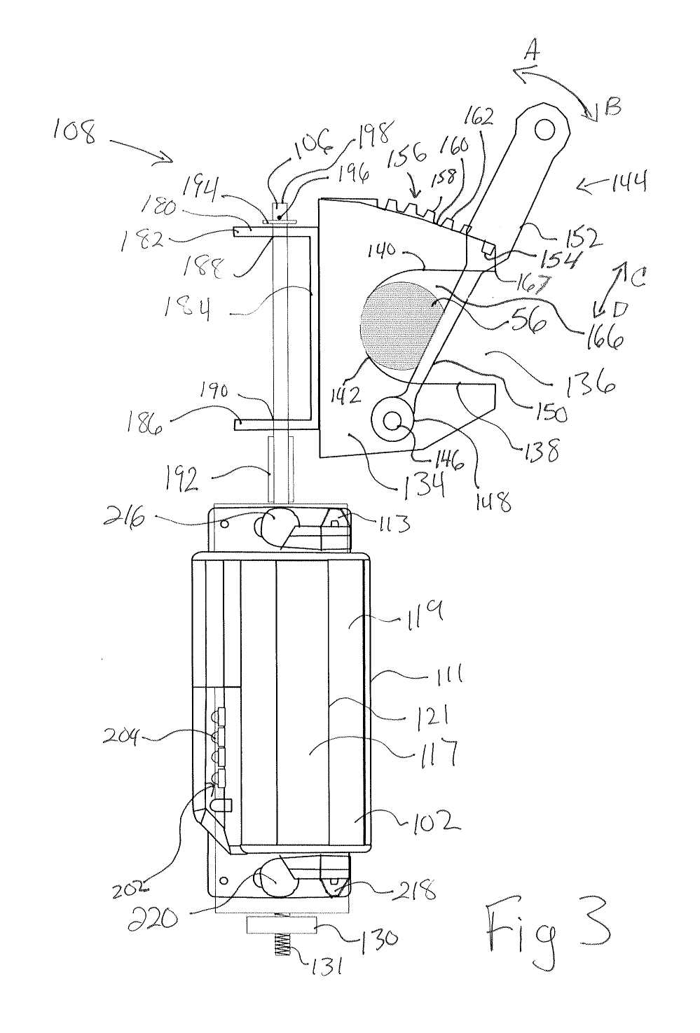

The locking arm is moveable about the pivot shaft 146 in the direction A of FIG. 3 toward the rail receiver 134 and toward the toothed sections 156, 164, and in the opposite direction B away from the rail receiver 134 and away the toothed sections 156, 164. Moving the locking arm in the direction A reduces an interior space 166 between the locking arm and the rail receiver 134. Moving the locking arm in the direction B increases the interior space 166 between the locking arm and the rail receiver 134. When the locking arm moves in direction B past an end 167 of the upper wall 140 an opening is created, which once the opening is large enough, the rung mount 108 can be withdrawn from the rung 56 and disconnected from the ladder 50.

When the crossbar is received in to one of the recesses of the toothed sections 156, 164 as shown in FIG. 3, the adjacent raised portions prevent the locking arm from moving in the directions A or B. By being prevented from moving in the direction B, the rung mount 108 is secured to the rung 56.

The locking bar is moveable in the longitudinal directions C and D as shown in FIG. 13. In order for the crossbar 154 to be received in a recess 160, the crossbar 154 must be raised in the direction C to surmount the raised portions 158, 162. In one embodiment, the locking arm or a portion thereof comprises an elastic rubber so that the user may draw the locking arm 134, by use of a t-handle 179, in the direction C to raise the crossbar relative to the toothed section, then the locking arm can be moved in the direction A until the crossbar is aligned with the desired recess. Then the user lowers the locking arm, which lowers the crossbar, in the direction D, as drawn by the elastic bias of the elastic rubber material, into the recess 160 below. While recess 160 is referred to here, any recess can be selected by the forgoing procedure. The locking arm is released from one of the recesses 160 of the toothed sections by raising the locking arm with the T-handle to withdraw the crossbar from the recess 160. While the locking arm is raised, the locking arm can be moved laterally in the direction B to remove locking arm from the toothed sections 156, 164.

The tension of the locking bar against the rung can be adjusted by raising the locking arm to withdraw the crossbar from one recess of the toothed sections and moving the locking arm in direction A or B, to tighten or loosen, respectively, contact between the locking arm and the rung, and then lowering the locking arm into a different recess of the toothed sections.

The rail receiver 134 is attached to the rail receiver mount 180. The rail receiver mount 180 is similar to the lighting main shaft mounts 112, 114. The rail receiver mount 180 comprises an upper portion 182, middle portion 184, and a lower portion 186. The portions 182, 186 are connected to middle portion 184 at right angles. The mount 180 has an open side opposite the middle portion 184. Each of the upper and lower portions 182, 186 comprise through-going upper and lower apertures 188, 190 respectively. The apertures 188, 190 are sized to receive the main shaft 106 there through. As shown in the FIG. 3, the main shaft extends through an open area between the upper and lower portions 182, 186 and the apertures 188, 190.

The rail receiver mount 180 is spaced from the upper main shaft mount 112 by a spacer 192 that is attached to the main shaft 106 as shown in FIG. 3. The spacer may be cylindrical. In some embodiments, the spacer is not fixed to the shaft 106 but floats, movable along the shaft 106.

The rail receiver mount 180 is prevented from being removed from a top end 198 of the shaft 106 by a stop washer 194 and a stop pin 196. The stop pin prevents the washer from moving above the stop pin along the shaft 106.

The lighting unit 102 comprises a housing 200. The housing has upper and lower mounting tabs 103, 105 with holes. The tabs and holes allow the housing to be mounted in various applications. The housing 200 has an opening or transparent front window 201. The front transparent window may comprise hard plastic that is resistant to damage under impact. In some embodiments the transparent window comprises a coating to protect against ultra violet light passing through the window.

In some embodiments, the housing comprises a front portion 117 joined to a rear portion 119 with one or more gaskets between the front and rear portions. The gasket(s) prevent dirt and moisture from entering the housing. In some embodiments, the housing is a sealed enclosure, including any button and cover of the housing, that is waterproof or water resistant. In some embodiments, the housing comprises polycarbonate for increased strength.

A lighting array/group 202 comprises a plurality of lights or lighting elements, such as LEDs (light emitting diodes) 204. In some embodiments, the lighting array/group 202 comprises a sub array of LEDs that provide white light and a sub array of LEDs that provide green light. In one embodiment, each LED of the LED bank provides between 60 and 180 lumens of light intensity. LEDs with other intensities can be used. The LED banks can comprise additional LEDs beyond what is shown in FIG. 2 to provide more or less lighting. The lighting unit can be provided with lights having any color within the visible spectrum.

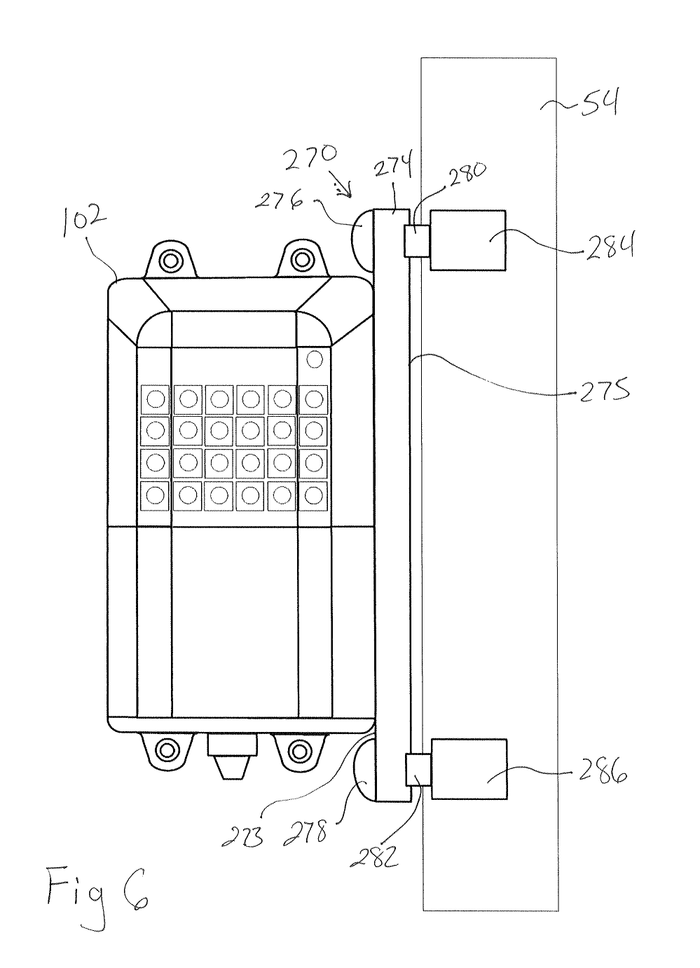

In some embodiments, the transparent front window 201 has beveled edges 131, 135. The beveled edges 131, 135 are angled at a 45 degree decline from the middle portion 139. The angled arrangement directs light from the left and right side rows 135, 137 of LEDs at up to 90 degrees from a straight forward path from the LEDs. Therefore left side row LEDs 135 are directed 90 degrees in the direction L in FIG. 6 from the straight forward path. Right side row LEDs 137 are directed 90 degrees in the direction M in FIG. 6 from the straight forward path. Therefore the lighting unit can provide light across an arc of a 180 degrees from the left to straight ahead to the right.

In some embodiments, the back surface 111 of the housing comprises a rear array of LEDs, protected by a transparent cover. A front/back switch 113 may be provided for a user to select whether the front lighting array 202 or back lighting array is illuminated. The switch 113 is signal connected to the controller and the back lighting array is signal connected to an LED driver 210 or a separate rear LED driver identical to LED driver 210. The rear LED driver is connected to the controller. In some embodiments, other lighting elements can be used in place of LEDs in the lighting array.

The lighting unit 102 comprises a processor/controller 206, a microprocessor header interface 208, an LED driver 210, a power supply 212, a voltage regulator 214, an on/off switch 216, a color selector 218, a mode selector 220, and a low battery indicator LED 222.

The controller 206 may be an application-specific integrated circuit (ASIC) having one or more processors and memory blocks including ROM, RAM, EEPROM, Flash, or the like; a programmed computer having a microprocessor, microcontroller, or other processor, a memory, and an input/output device; a programmable integrated electronic circuit; a programmable logic controller or device; or the like. Any device or combination of devices on which a finite state machine capable of implementing the procedures described herein can be used as the controller 206.

The controller is in signal communication with the microprocessor header interface 208, the LED driver 210, the power supply 212, the voltage regulator 214, the color selector 218, the mode selector 220, and the low battery indicator LED 222. The power supply may comprise one or more batteries. The batteries may be rechargeable. In some embodiments, the batteries will supply between 20 and 30 hours of continuous lighted operation. The LED driver 210 relays power to the lighting array 202 according to the instructions provided by the controller. The voltage regular ensures that a constant voltage level in the circuit within a given range.

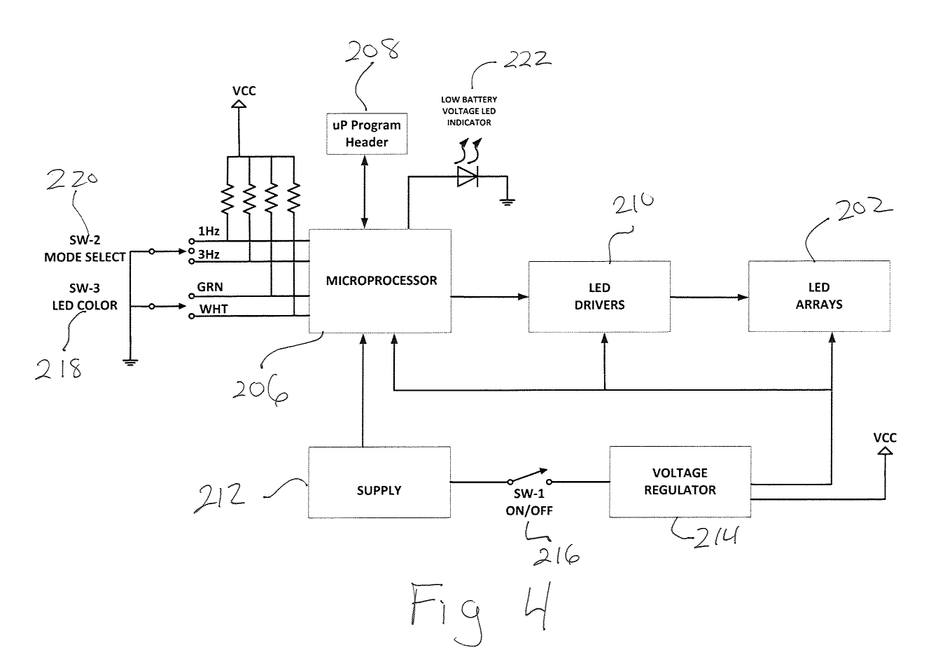

The on/off switch 216 connects the circuit to supply power to the circuit shown in FIG. 4 or disconnects the circuit to stop power. When the on/off switch is pressed the controller will direct power from the power supply the lighting array 202 if the LEDs were off immediately prior to the button being pushed. If the LEDs are on immediately prior to the on/off switch being pushed, then the controller will direct that power be stopped to the LEDs to turn them off when the button is pushed.

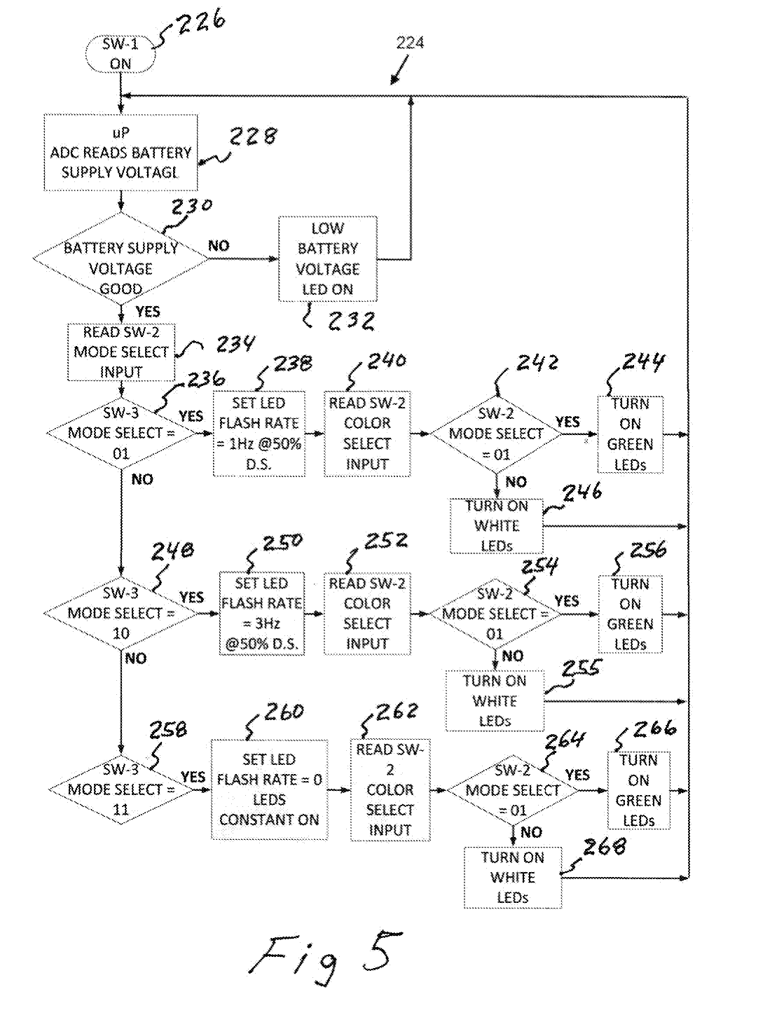

FIG. 5 illustrates one embodiment of the operation of the controller. At step 226, the power switch is on. The controller has a function to measure the power level of the power supply and indicate when the battery power level is below a pre-defined threshold, such as 10, 7, 5, or 3 percent, or threshold below which batteries cannot provide stable power to the LEDs. At step 228, the controller calls the function to measure the power level of the power supply. If the power is measured to be below the pre-defined threshold then the controller will moved to step 232 and will cause power to be directed to the low battery indicator LED 222 to cause it to illuminate to indicate a low battery condition to the user. In some embodiments, the low battery LED is flashed at a rate of 1 hertz.

If the battery power is above the pre-defined threshold, then the controller will move to step 234 and read the mode selector input. At step 236, if the mode is set to 01 or flash at a first rate, then the controller will move to step 238 and prepare/set instructions for the LED driver 210 to flash the LED on/off at a first rate, such as 1 Hertz. Next the controller will read the color selector 218 at step 240. Before delivering the instructions to flash, the controller will move to step 242 to determine the selection that is set at the color selector 218. If green is selected, the controller will move to step 244 to instruct the LED driver to flash on and off the green LED sub array at the first rate. If at step 242 the color selector indicates white, the controller will move to step 246 to instruct the LED driver to flash on and off the white LED sub array at the first rate.

If at step 236, the mode selector is set to 10 or to flash at second rate, then the controller will move to step 248 and then 250 and prepare/set instructions for the LED driver 210 to flash the LED on/off at a second rate, such as 3 Hertz. Next the controller will read the color selector 218 at step 252. Before delivering the instructions to flash, the controller will move to step 254. If at step 264 the color selector is set to green, the controller will move to step 256 to instruct the LED driver to flash on and off the green LED sub array at the second rate. If at step 264 the color selector indicates white, the controller will move to step 268 to instruct the LED driver to flash on and off the white LED sub array at the second rate. The controller can be configured to flash the lights at different frequency rates, including frequency rates where the human eye can detect the on and off of the flash as well as higher rates where the human eye cannot perceive the flashing.

If at step 236 or step 248 the mode selector is set to 11 or constant on, then the controller will go to step 258 and proceed to step 260 to prepare/set instructions for the LED driver turn on constantly the LEDs. Before delivering the instructions to turn on the LEDs, the controller will move to step 262 and read the color selector. If the color selector is set to green, the controller will move to step 266 to instruct the LED driver to turn on the green LED sub array. If at step 254 the color selector indicates white, the controller will move to step 255 to instruct the LED driver to turn on the white LED sub array.

Other lighting features and processes can be software programmed via a connection to the microprocessor header interface 208. In some embodiments, the controller can be programmed to cause the lighting array to flash a Morse Code or other types of signal code according to a user-inputted message or a predefined message.

In some embodiments, the controller has a light-to-power adjustment function to adjust the LED light intensity based on the battery power remaining in the power supply. In one embodiment of the function, when the controller detects the power supply has a voltage level of 100, 95, 90, 80, and 70 percent, the lighting intensity is set to 100, 95, 80, and 70 percent, respectively. In some embodiments, the low battery indicator LED will be illuminated when the power level is below 70%. In some embodiments, the lighting array(s) will be turn off and the low battery indicator LED will be turned on when the battery voltage is below 65 percent.

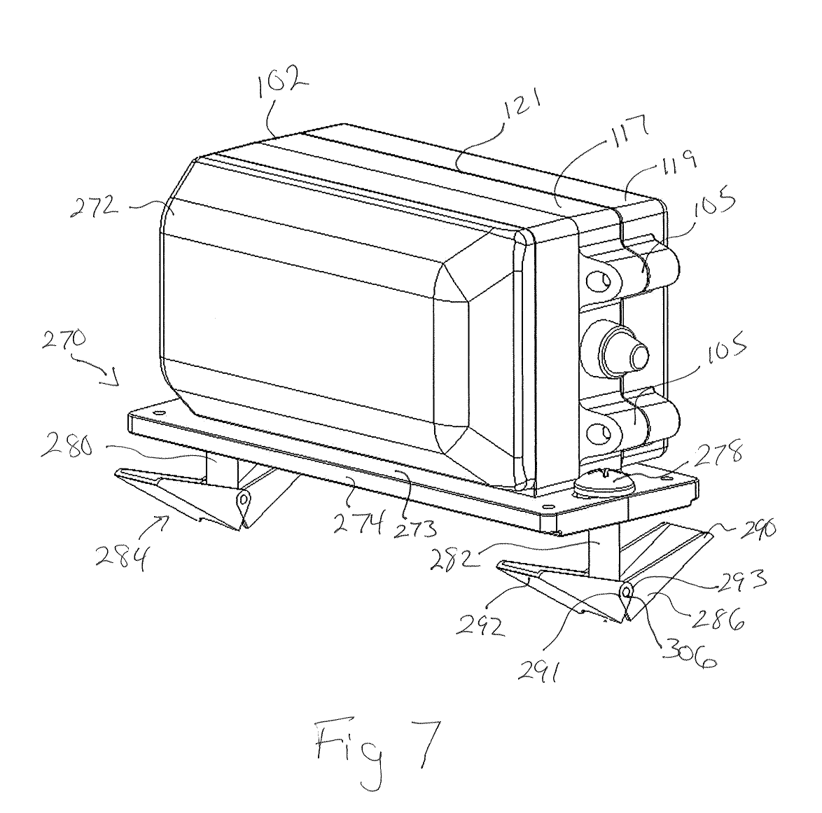

FIGS. 6 and 7, shows a second embodiment ladder light assembly 199 having the lighting unit 102 mounted to a rail mount 270. In FIG. 7, the lighting unit 102 is shown with an opaque cover 272 covering the front including the LEDs. The rail mount 270 comprises a plate 274 having a lighting side surface 273 and a rail side surface 275. The lighting unit 102 attaches to the lighting side surface 273 of the plate 274 by fasteners (not shown). Fasteners such as bolts 276, 278 extend through the plate 274. The heads of the bolts are on the lighting side surface 273 and the shafts 280, 282 extend through the plate below the rail side surface 275. The shafts 280, 282 are at least partially threaded 288. Toggle bolt anchors 284, 286 are then threaded on to the corresponding shaft 280, 282.

The toggle bolt anchors are identical, so only anchor 286 will be described. The anchor has two wings 290, 292, a spring, and a middle member 300. The spring comprises a first portion 294, a second portion 296, and a looped middle portion 298. The middle member 300 has a threaded opening 301 and two stubs 302, 304 on opposite side of the opening 301. Each of the wings have pivot holes 306 at a joining end 291, 293 of the corresponding wing on both sides of the wing. The wings are pivotally mounted to the middle member at the stubs 302, 304.

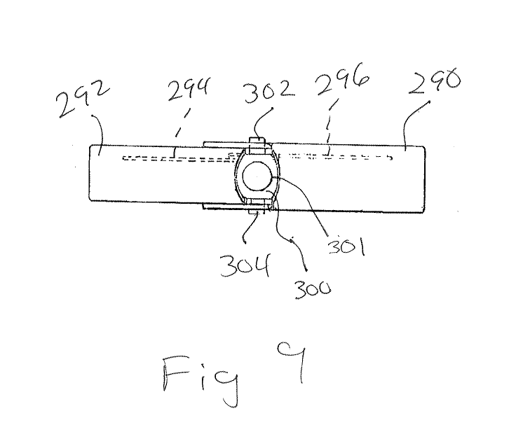

The stubs extend through the holes 306 and the wings pivot about the stubs in the closing directions E, H and the opening directions F, I. The spring may be looped around one of the stubs as shown in FIG. 9. The spring biases each wing in the opening direction F, I. The threaded opening 301 of the anchor engages threads 288 on the bolt 278 to join the anchor 286 to the bolt 278. In some embodiments, the toggle anchor is the toggle anchor shown in U.S. Pat. No. 1,228,512, which is incorporated herein by reference.

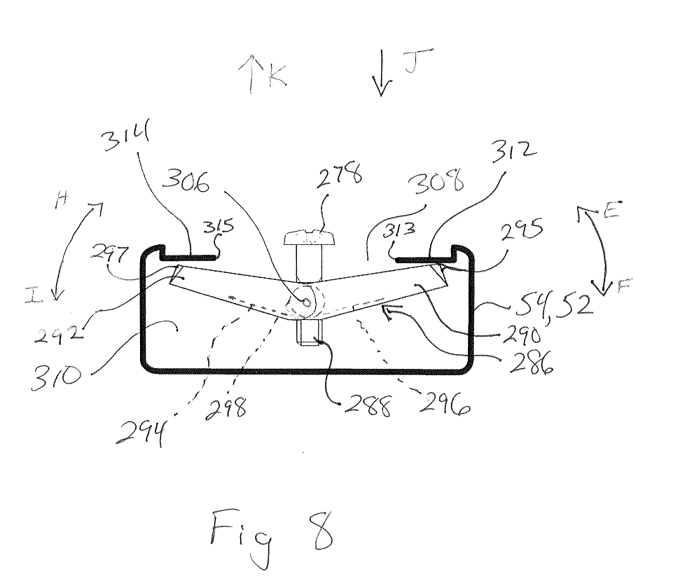

In some applications, the ladder has an opening 308 into a channel 310 in the side rail 52, 54. Opposite segments 312, 314 bound the opening 308. In order to attach the rail mount 270 to the rail 52, 54, the wings 290, 292 are placed against the corresponding segments 312, 314. Then the rail mount 270 is pushed in the direction J of FIG. 8. This force in the direction J overcomes the spring bias at the wings of the anchor and causes the wings 290, 292 to move in the directions E, H toward a closed position where the outer ends 295, 297 of the wings are closer to the bolt 278. Once the wings are move toward the close position to an extent that outer ends 295, 297 are within the ends 313, 315 of the segments 213, 314, the outer ends 295, 297 will pass the segments 312, 314 and move into the channel 310.

When the outer ends 295, 297 are past, in the direction E, the ends 313, 315 of the segments 213, 314, then the spring bias of the spring of the anchor will drive the wings toward the open position, in the directions F, I, under the ends 313, 315 of the rail. With the wings in the open position as shown in FIG. 8, the bolt and the anchor will be prevented from withdraw from the channel 310, in the direction K, by contact between the wings and the underside of the segments 312, 314. The rail mount 270 may be further secured to the rail by tightening the bolts, which will draw the plate 274 against the outside of the rail and will also draw the wings against the underside of the rail to create gripping tension to prevent the movement of the rail mount and lighting unit relative to the rail.

In some embodiments, the lighting unit 102 comprises a wireless communications device, a temperature sensor, a location determining device and/or function, each in signal communication with the controller. The controller can be configured to read the temperature provided by the temperature sensor, determine the units location by calling the location determining device and/or function device for location information, and then can send that temperature and/or location information via the wireless communication device to a remote computer or mobile computing device 316. The controller could also be configured to transmit the temperature reading provided by the temperature sensor to the LEDs in a Morse Code or other flashing or signal based code. In one embodiment, the location determining device and/or function is a GPS device.

The wireless communications device can be one capable and configured to transmit data wirelessly using a long distance wireless protocol, such as cellular wireless standards, including GSM, 3G, 4G, 4G LTE or 5G wireless standards. In some embodiments, the wireless communication device is capable and configured to transmit data wirelessly to communicate with WiFi enabled devices, such as by utilizing on IEEE 802.11 standard for wireless communication. In some embodiments, the wireless communication device may be capable and configured to transmit data wirelessly with other devices under a short range standard or low-power standard, such as the Bluetooth standard.

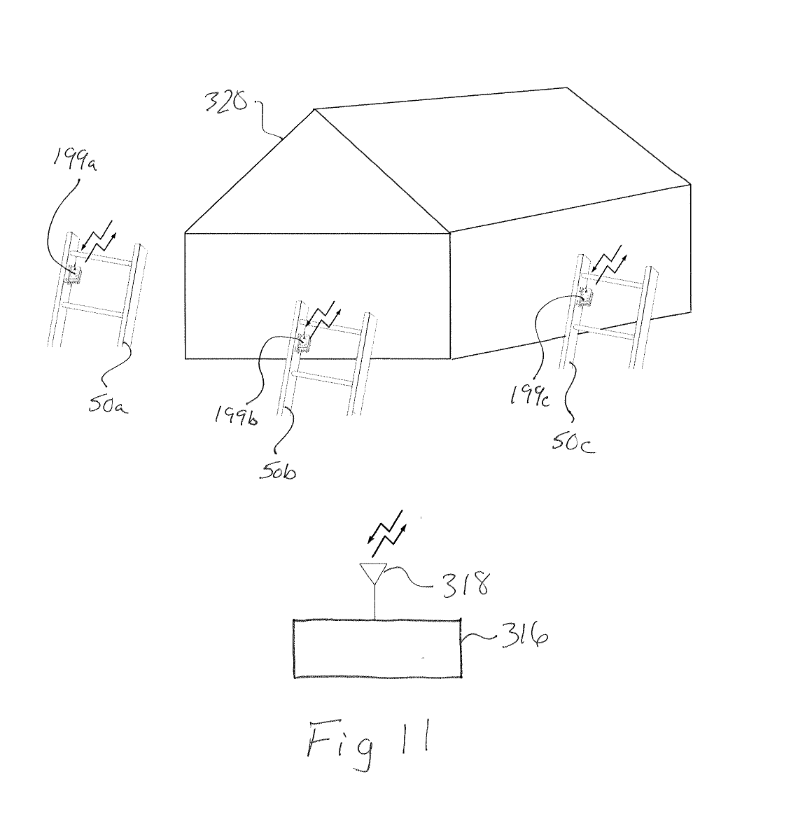

FIG. 11 shows the remote computer or mobile computing device 316 in one application with the latter light assemblies 199a, 199b, 199c. The remote computer or mobile computing device 316 has a wireless communications device 318 capable of wirelessly communicating and transmitting data to the wireless communication device of the lighting unit 102 using one or more of the protocols described above. The device 318 may comprise an application-specific integrated circuit (ASIC) having one or more processors and memory blocks including ROM, RAM, EEPROM, Flash, or the like; a programmed computer having a microprocessor, microcontroller, or other processor, a memory, an input/output device, and a display; a programmable integrated electronic circuit; a programmable logic controller or device; or the like.

The device 316 may be located at a mobile communications and command center set up at a location at or adjacent the location where the ladder light assemblies 199 need to be used, such as at a fire or other emergency or event at a structure 320.

Multiple ladder light assemblies 199a, 199b, 199c—which are identical to ladder light assembly 199, but could also be ladder light assembly 100—can be deployed on corresponding ladders 50a, 50b, 50c, which are identical to ladder 50, and located about the structure 320. The controllers of each of the assemblies 199a, 199b, 199c can communicate the temperature measured by the corresponding temperature sensors and/or the location of the assembly as reported by the location determining device and/or function of the assembly to the device 316. A commander or other user can monitor temperatures at the various locations about the structure to monitor the conditions. The location information reported by the assemblies provides the user at the device 316 with real-time or regularly updated location information about the location of the assemblies and the corresponding ladders. Therefore a user at the device 316 can make decisions and radio instructions to the firefighters in or about the structure based on the temperature or other information reported to the device 316 by the ladder light assemblies 199a, 199b, 199c at the various locations about the scene.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A lighting assembly for a ladder, comprising:
a lighting unit comprising a housing, a controller, at least one light element, and a user input device, the controller signal connected to the user input device and the at least one light element; and,
a mount connected to the lighting unit, the mount comprising a ladder rung receiver and a locking arm, the locking arm movable between an open position to allow a ladder rung to be received in the rung receiver and at least one closed position securing the ladder run in the rung receiver.

2. The assembly of claim 1, the mount comprises a mounting member and a shaft, the lighting unit is connected to the mounting member, the mounting member is rotateably connected to the shaft.

3. The assembly of claim 2, wherein the rung receiver is attached to the shaft opposite of the mounting member.

4. The assembly of claim 3, wherein the rung receiver is rotatably mounted to the shaft.

5. The assembly of claim 4, the mount comprises a locking mechanism to releasably lock the rung receiver against rotation

6. The assembly of claim 2, wherein the mount comprises a locking mechanism to releasably lock the mounting member against rotation.

7. The assembly of claim 1, wherein the rung receiver comprises a plurality of recesses; the locking arm is pivotally attached to the run receiver, the locking arm is engagable with at least one of the plurality of recesses to releaseably lock the locking arm in the at least one closed position.

8. The assembly of claim 7, wherein the locking arm is moveable from an extended position, where the locking arm is released from the plurality of recesses and a retracted position where the locking arm is engaged with at least one of the plurality of recesses.

9. The assembly of claim 7, wherein the at least one closed position comprises a plurality of closed positions, each closed position corresponding to one of the plurality of recesses; the locking arm movable between the plurality of closed positions to vary the area between the locking arm and the rung receiver.

10. The assembly of claim 1, wherein the at least one light element is an LED group comprising a first LED subgroup and a second LED subgroup, the first LED subgroup comprising LEDs of a first color, the second LED subgroup comprising LEDs of a second color; the user input device comprises a lighting color selector; the controller comprises a function to illuminate the first or second LED subgroup depending on the color indicated by the user via the color selector.

11. The assembly of claim 1, wherein the user input device comprises a mode color selector; the controller comprising a function to illuminate the at least one light element constantly or to flash the at least one light element on and off depending on the mode indicated by the user via the mode selector.

12. A lighting assembly for a ladder, comprising:
a lighting unit comprising a housing, a controller, at least one light element, and a user input device, the controller signal connected to the user input device and the at least one light element; and,
a mount connected to the lighting unit, the mount comprises a toggle anchor for engaging a ladder side rail channel.

13. The assembly of claim 12, wherein the mount comprises a lighting unit mounting member and threaded shaft connected to the mounting member; the toggle anchor engagable with the threaded shaft.

14. The assembly of claim 12, wherein the mount comprises a mounting member and a threaded shaft, the threaded shaft connectable to the mounting member; the toggle anchor comprises two wings, a spring, and a threaded member; the wings are pivotally mounted to the threaded member, the wings are pivotal between a closed position and an open position; the spring is attached to the threaded member and contacts each of the wings to bias the wings toward the open position, the threaded shaft connects to the threaded member of the toggle anchor.

15. The assembly of claim 14, wherein the threaded shaft is rotatable to tighten or loosen the toggle anchor relative to the mounting member to secure the toggle anchor within a ladder side rail channel.

16. The assembly of claim 12, wherein the at least one light element is an LED group comprises a first LED subgroup and a second LED subgroup, the first LED subgroup comprising LEDs of a first color, the second LED subgroup comprising LEDs of a second color; the user input device comprises a lighting color selector; the controller comprising a function to illuminate the first or second LED subgroup depending on the color indicated by the user via the color selector.

17. The assembly of claim 12, wherein at least one light element is an LED group comprising a plurality of LEDs and wherein the user input device comprises a mode color selector; the controller comprising a function to illuminate the LED group constantly or to flash the LED group on and off depending on the mode indicated by the user via the mode selector.

18. The assembly of claim 12, wherein the lighting unit comprises a temperature sensor.

19. The assembly of claim 12, wherein the lighting unit comprises a location determining device.

20. The assembly of claim 12, wherein the lighting unit comprise a wireless communication device for transmitting temperature data or location data to a remote computing device.
